(19) United States
(12) Patent Application Publication
(10) Pub. No.: US 2006/0175794 A1
(43) Pub. Date: Aug. 10, 2006

(54) Pedaling vehicle with a gear train for delivering an increasing angular speed

(76) Inventor: I. D. Chen, Taichung Hsien (TW)

Correspondence Address: HARNESS, DICKEY & PIERCE, P.L.C., P.O. BOX 8910, RESTON, VA, 20195, US

(21) Appl. No.: 11/054,062

(22) Filed: Feb. 10, 2005

(51) Int. Cl. B62M 1/02

(52) U.S. Cl. 280/260

(57) ABSTRACT

A pedaling vehicle includes a crank shaft extending along and rotatable relative to a frame body about a crank axis and operated by pedals. A tubular coupler is mounted on and is rotatable relative to a mounting segment of the crank shaft about the crank axis. A chainwheel is secured on a first coupling end of the tubular coupler to be rotated with the tubular coupler about the crank axis so as to drive a wheel body to rotate. A gear train includes initial and final gears which are of such a gear ratio as to enable the final gear to deliver an increased angular speed, and which are coupled with the driving segment of the crank shaft and a second coupling end of the tubular coupler, respectively, so as to transmit the increased angular speed of the final gear to the tubular coupler, thereby driving the chainwheel to rotate.

### BACKGROUND OF THE INVENTION

1. Field of the Invention

This invention relates to a pedaling vehicle, more particularly to a pedaling vehicle, such as a bicycle, which has a gear train enabling delivery of an increased angular speed from a crank shaft to a chainwheel.

2. Description of the Related Art

Bicycles have been developed to have a compact size to facilitate transportation or storage. To maintain a good power transmitting effect, a compact-sized bicycle generally has a chainwheel of a relatively large dimension in relation to a bicycle frame, thereby causing inconvenience to the rider when mounting or dismounting the bicycle. Moreover, the rider's clothes may be caught in the chainwheel.

### SUMMARY OF THE INVENTION

The object of the present invention is to provide a pedaling vehicle which has a gear train enabling delivery of an increased angular speed from a crank shaft to a chainwheel so as to permit a reduction in the dimension of the chainwheel for convenient riding.

According to this invention, the pedaling vehicle includes a crank shaft extending along and rotatable relative to a frame body about a crank axis, and having left and right ends that are respectively coupled with crank arms that are operated by pedals, and an intermediate portion interposed between the left and right ends. The intermediate portion has a driving segment and a mounting segment opposite to each other along the crank axis. A tubular coupler is mounted on and is rotatable relative to the mounting segment about the crank axis, and has first and second coupling ends proximate to the left end and the driving segment of the crank shaft, respectively. A chainwheel is secured on the first coupling end of the tubular coupler to be rotated with the tubular coupler about the crank axis so as to drive a wheel body to rotate. A gear train includes initial and final gears which are of such a gear ratio as to enable the final gear to deliver an increased angular speed, and which are coupled with the driving segment of the crank shaft and the second coupling end of the tubular coupler, respectively, so as to transmit the increased angular speed of the final gear to the tubular coupler, thereby driving the chainwheel to rotate.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic side view of the preferred embodiment of a pedaling vehicle according to this invention;

FIG. 2 is a partly sectional view showing a crank shaft and a gear train of the preferred embodiment; and

FIG. 3 is a partly cross-sectional view of the crank shaft and the gear train of the preferred embodiment.

### DETAILED DESCRIPTION OF THE PREFERRED EMBODIMENT

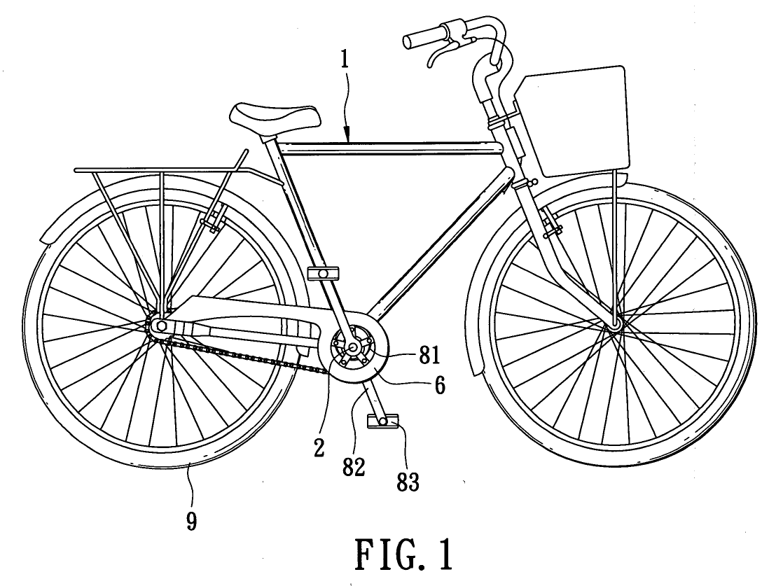

Referring to FIGS. 1 to 3, the preferred embodiment of a pedaling vehicle according to the present invention is shown to be in the form of a bicycle, and comprises a housing mounted in a frame tube 81 of a frame body 1, a crank shaft 2, a pair of crank arms 82, a tubular coupler 5, a chainwheel 6, a wheel body 9, and a gear train 4.

The housing includes a right mount 13 which has an inner peripheral wall surrounding a crank axis, a right support portion 14 which extends from the right mount 13 radially and which terminates at a distal end to engage the frame tube 81, a confining wall 12 which extends from the right support portion 14 leftwardly, which terminates at an end region 121 and which defines an accommodation space 11 therein, and a left support portion 15 which is suspended from the end region 121 and which extends radially towards the crank axis to terminate at a left mount 16.

The crank shaft 2 extends along and is rotatable relative to the frame body 1 about the crank axis, and includes left and right ends 21, 22, an intermediate portion which is interposed therebetween and which has a driving segment 23 and a mounting segment 24 opposite to each other along the crank axis, a left journalled portion 25 which is interposed between the mounting segment 24 and the left end 21, and a right journalled portion 26 which is interposed between the driving segment 23 and the right end 22. The inner peripheral wall of the right mount 13 is disposed to surround the right journalled portion 26 such that a right bearing member 71 is interposed between the inner peripheral wall of the right mount 13 and the right journalled portion 26 to reduce friction therebetween when the crank shaft 2 is rotated relative to the frame body 1.

Each of the crank arms 82 is coupled to a respective one of the left and right ends 21, 22 of the crank shaft 2, and is operated by a pedal 83 to synchronously drive the crank shaft 2 to rotate about the crank axis.

The tubular coupler 5 is mounted on and is rotatable relative to the mounting segment 24 about the crank axis. Specifically, the tubular coupler 5 includes first and second coupling ends 51, 52 proximate to the left end 21 and the driving segment 23 of the crank shaft 2, respectively, and an intermediate segment interposed therebetween. The intermediate segment includes an annular journalled region 53, an annular abutment region 54 which is interposed between the annular journalled region 53 and the first coupling end 51, and which cooperates with the annular journalled region 53 to form an annular barrier surface 55, and a stabilizing region 56 which is interposed between the annular journalled region 53 and the second coupling end 52 and which is spaced apart from the end region 121 radially so as to define the accommodation space 11 in cooperation therewith. Moreover, the left mount 16 is of such a tubular form as to surround both the mounting segment 24 of the crank shaft 2 and the annular journalled region 53 about the crank axis.

Furthermore, the left mount 16 has a left journal surface 161 which confronts the annular journalled region 53. A left bearing member 72 is interposed between the left journal surface 161 and the annular journalled region 53 to reduce the friction therebetween when the tubular coupler 5 is rotated relative to the left mount 16.

The chainwheel 6 is secured on the first coupling end 51 of the tubular coupler 5 so as to be rotated with the tubular coupler 5 about the crank axis.

The wheel body 9, such as a rear wheel, is rotatably mounted on the frame body 1, and is coupled with the chainwheel 6 in a known manner so as to be driven by the chainwheel 6.

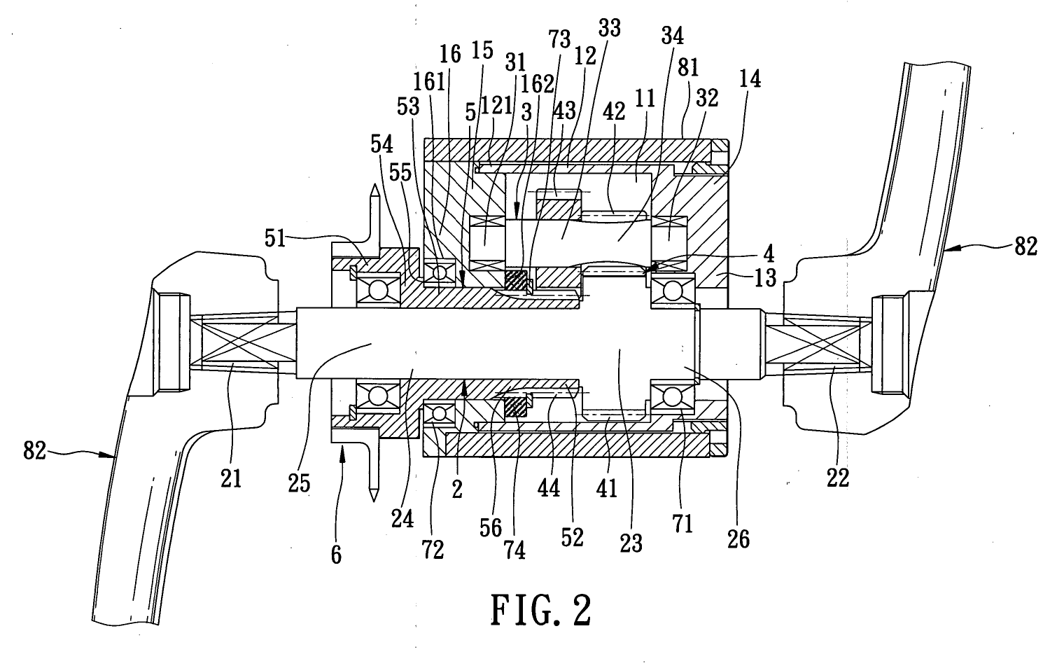

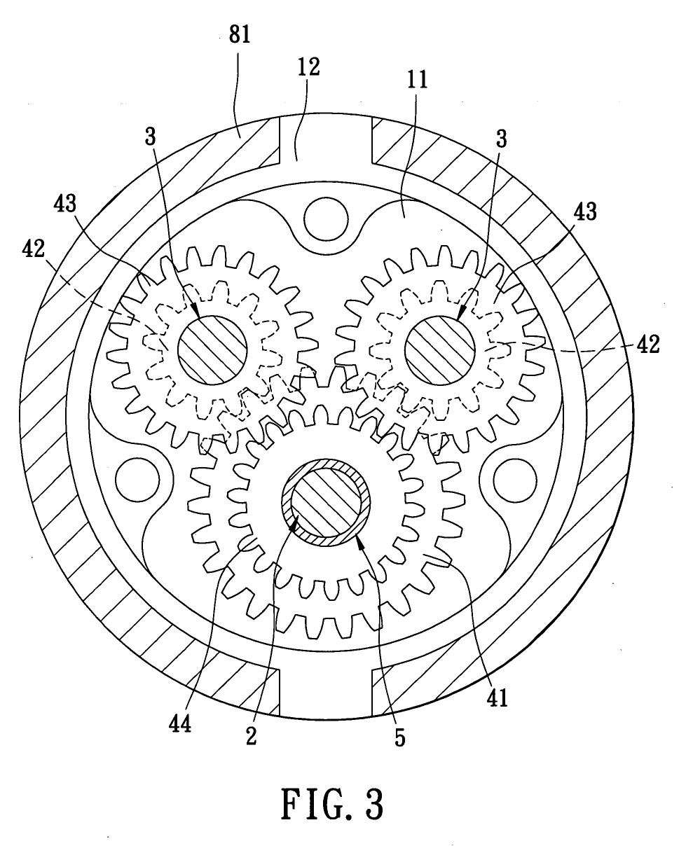

With reference to FIGS. 2 and 3, the gear train 4 is received in the accommodation space 11, and includes an initial gear 41, first and second transmitting shafts 3, first and second transmitting gears 42, first and second driven gears 43, and a final gear 44.

The initial gear 41 is mounted on and is rotated with the driving segment 23 of the crank shaft 2. The first and second transmitting shafts 3 are rotatable relative to the frame body 1 about first and second rotation axes that are parallel to the crank axis and that are angularly displaced from each other about the crank axis. Each of the first and second transmitting shafts 3 includes left and right transmitting segments 33, 34 opposite to each other along a respective one of the first and second rotation axes, and left and right support ends 31, 32 which respectively extend from the left and right transmitting segments 33, 34 along the respective one of the first and second rotation axes and which are rotatably mounted on the left and right support portions 16, 13, respectively. Each of the first and second transmitting gears 42 is mounted on and is rotated with the right transmitting segment 34 of a respective one of the first and second transmitting shafts 3, meshes with the initial gear 41, and is of a dimension smaller than that of the initial gear 41. Each of the first and second driven gears 43 is mounted on and is rotated with the left transmitting segment 33 of the respective one of the first and second transmitting shafts 3, meshes with the final gear 44, and is of a dimension larger than that of the final gear 44. The final gear 44 is coupled with the second coupling end 52 of the tubular coupler 5.

Moreover, the left mount 16 has a retained surface 162 which confronts the first driven gears 43, and which is opposite to the left bearing member 72 in a direction parallel to the crank axis. A retaining member 73 in the form of a C-shaped clamp is disposed to be rotated with the stabilizing region 56 of the tubular coupler 5, and confronts the retained surface 162 in the parallel direction such that the tubular coupler 5 is restrained from shifting along the crank axis relative to the left mount 16 when the tubular coupler 5 is rotated relative to both the left mount 16 and the crank shaft 2. Furthermore, a stabilizing member 74 is disposed between the retaining member 73 and the retained surface 162. Thus, the left bearing member 72 is restrained from moving away from the annular barrier surface 55 when the retaining member 73 is rotated with the tubular coupler 5 relative to both the left mount 16 and the crank shaft 2 so as to warrant smooth transmission of an increased angular speed to the tubular coupler 5, thereby effectively driving the chainwheel 6 to rotate.

When the rider treads the pedals 83 to rotate the crank shaft 2, a rotational force is transmitted by the gear train 4, i.e. the initial gear 41, the first and second transmitting gears 42, the first and second transmitting shafts 3, the first and second driven gears 43, and the final gear 44 in sequence, such that the final gear 44 can deliver an increased angular speed for transmission to the tubular coupler 5, thereby driving the chainwheel 6 to rotate at an increased rotational speed. Thus, the frame body 1 and the chainwheel 6 of the pedaling vehicle of this invention may have a compact size while maintaining a desired rotational speed of the pedaling vehicle. Besides, the rider's clothes will not be easily caught in the chainwheel, and the rider can mount and dismount the vehicle with convenience.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A pedaling vehicle comprising:
a frame body;
a crank shaft extending along and rotatable relative to said frame body about a crank axis, and having left and right ends, and an intermediate portion interposed therebetween, said intermediate portion having a driving segment and a mounting segment opposite to each other along the crank axis;
a pair of crank arms, each coupled to a respective one of said left and right ends of said crank shaft, and each adapted to be operated by a pedal to synchronously drive said crank shaft to rotate about the crank axis;
a tubular coupler mounted on and rotatable relative to said mounting segment about the crank axis, and having first and second coupling ends proximate to said left end and said driving segment of said crank shaft, respectively;
a chainwheel secured on said first coupling end of said tubular coupler so as to be rotated with said tubular coupler about the crank axis;
a wheel body rotatably mounted on said frame body, and coupled with said chainwheel so as to be driven by said chainwheel; and
a gear train including initial and final gears which are of such a gear ratio as to enable said final gear to deliver an increased angular speed, and which are coupled with said driving segment of said crank shaft and said second coupling end of said tubular coupler, respectively, so as to transmit the increased angular speed of said final gear to said tubular coupler, thereby driving said chainwheel to rotate.

2. The pedaling vehicle of claim 1, wherein said gear train further includes
a first transmitting shaft rotatable relative to said frame body about a first rotation axis parallel to the crank axis, and having left and right transmitting segments opposite to each other along the first rotation axis;
a first transmitting gear mounted on and rotated with said right transmitting segment of said first transmitting shaft, meshing with said initial gear, and having a dimension smaller than that of said initial gear; and
a first driven gear mounted on and rotated with said left transmitting segment of said first transmitting shaft, and meshing with said final gear.

3. The pedaling vehicle of claim 2, wherein said first driven gear is of a dimension larger than that of said final gear.

4. The pedaling vehicle of claim 2, wherein said gear train further includes
a second transmitting shaft which is rotatable relative to said frame body about a second rotation axis that is parallel to the crank axis and that is angularly displaced from the first rotation axis about the crank axis, and which has left and right transmitting segments opposite to each other along the second rotation axis;
a second transmitting gear mounted on and rotated with said right transmitting segment of said second transmitting shaft, meshing with said initial gear, and having a dimension smaller than that of said initial gear; and
a second driven gear mounted on and rotated with said left transmitting segment of said second transmitting shaft, and meshing with said final gear.

5. The pedaling vehicle of claim 2, wherein said crank shaft includes a left journalled portion which is interposed between said mounting segment and said left end, and a right journalled portion which is interposed between said driving segment and said right end, said frame body including a right mount which has an inner peripheral wall surrounding said right journalled portion, and a right support portion which extends from said right mount radially and which terminates at a distal end, said pedaling vehicle further comprising a right bearing member interposed between said inner peripheral wall of said right mount and said right journalled portion to reduce friction therebetween when said crank shaft is rotated relative to said frame body.

6. The pedaling vehicle of claim 5, wherein said tubular coupler includes an intermediate segment which is interposed between said first and second coupling ends, and which includes
an annular journalled region,
an annular abutment region that is interposed between said annular journalled region and said first coupling end, and that cooperates with said annular journalled region to form an annular barrier surface, and
a stabilizing region that is interposed between said annular journalled region and said second coupling end, said frame body further including a confining wall which extends from said right support portion towards said chainwheel and which terminates at an end region that is spaced apart from said stabilizing region radially so as to define an accommodation space to accommodate said first transmitting shaft.

7. The pedaling vehicle of claim 6, wherein said frame body includes a left support portion which is suspended from said end region, which extends towards said annular journalled region, and which terminates at a left mount that has a left journal surface confronting said annular journalled region, said pedaling vehicle further comprising a left bearing member interposed between said left journal surface and said annular journalled region to reduce friction therebetween when said tubular coupler is rotated relative to said left mount.

8. The pedaling vehicle of claim 7, wherein said first transmitting shaft includes left and right supported ends which respectively extend from said left and right segments respectively along the first rotation axis, and which are rotatably mounted on said left and right support portions, respectively.

9. The pedaling vehicle of claim 8, wherein said left mount has a retained surface which confronts said first driven gear, and which is opposite to said left bearing member in a direction parallel to the crank axis, said pedaling vehicle further comprising a retaining member disposed to be rotated with said stabilizing region, and to confront said retained surface in the parallel direction such that said tubular coupler is restrained from shifting along the crank axis relative to said left mount when said tubular coupler is rotated relative to both said left mount and said crank shaft.

10. The pedaling vehicle of claim 9, further comprising a stabilizing member disposed between said retaining member and said retained surface such that said left bearing member is restrained from moving away from said annular barrier surface when said retaining member is rotated with said tubular coupler relative to both said left mount and said crank shaft so as to warrant a smooth transmission of the increased angular speed to said tubular coupler, thereby effectively driving said chainwheel to rotate.

11. The pedaling vehicle of claim 10, wherein said left mount is of such a tubular form as to surround both said mounting segment of said crank shaft and said annular journalled region about the crank axis.
